(19) United States
(12) Patent Application Publication
(10) Pub. No.: US 2014/0096370 A1
(43) Pub. Date: Apr. 10, 2014

(54) DEVICE AND METHOD FOR SETTING VEHICLE IGNITION SYSTEM

(71) Applicant: GIUSEPPE LAURITANO, Redwood City, CA (US)

(72) Inventor: GIUSEPPE LAURITANO, Redwood City, CA (US)

(21) Appl. No.: 13/645,033

(22) Filed: Oct. 4, 2012

(51) Int. Cl. B23P 6/00

(52) U.S. Cl. 29/592.1; 29/33 R

(57) ABSTRACT

A device for setting a vehicle ignition current source having a movable mounting plate located on the base of a housing utilizing a gauge which positions relative to the housing. The gauge includes a guide for creating an opening in the base of the housing. A shaft extends into the opening in the base of the housing and contacts the movable mounting plate to fix the position of the same relative to the housing base.

### BACKGROUND OF THE INVENTION

The present invention relates to a novel and useful device and method for setting a vehicle ignition timing.

Ignition systems are used in vehicles to ignite a fuel-air mixture to power internal combustion engines. Timed electrical systems include a distributor or magneto. The distributor generally contains a rotating cam driven by a drive linkage from the engine. Also, a set of breaker points, a condenser, a rotor, and a distributor cap are included in the distributor or magneto. In a mechanically timed ignition system, generally the set of breaker points are located on a pair of plates. One of the plates is often referred to as at an ignition adjustor plate, timing plate, or breaker plate. Such movable plate serves as a mount for one of the breakers or contacts.

As an engine turns, a cam inside a breaker housing also turns. One of the points or contact breakers positioned on an arm rides on the cam so that as the engine turns it reaches the top of the engine's compression cycle. A high point in the cam causes the breakers to open to a certain gap. This opening between the breakers causes the primary winding circuit to interrupt and stops the current through the breaker points. Such contact and opening of the breaker points is employed to ignite an engine through a series of spark plugs and the remaining conventional components of an ignition system, such as a coil and a condenser.

It is important, however, to set the gap or opening between breaker points to determine the efficiency and performance of an engine.

In the past, the maximum opening gap between the breaker points has been determined using a feeler gauge and adjusting the movable mounting plate having one of the breaker points to a particular distance between the other breaker point, typically, measured in thousands of an inch. Such adjustment must be accomplished periodically since the breaker points tends to drift out of adjustment.

It should be realized that a device and method for setting the gap between the breaker points of an ignition system of a vehicle engine, would be a notable advance in the field of vehicle engines.

### SUMMARY OF THE INVENTION

In accordance with the present invention a novel and useful device and method for setting the gap of a pair of contacts in a vehicle ignition system, having a movable mounting plate for one contact located on a base of a housing.

The device of the present invention utilizes a gauge which is positioned relative to the housing. The gauge may take the form of a sheet or plate which substitutes for the cover of the housing for the mounting plate, supporting one of the contacts. Thus, the gauge is then positioned in place of the cover of the housing to lie over the base of the housing. The gage includes a guide, which may be in the form of an orthogonal passageway through the gauge. The guide is intended to direct a cutting instrument, such as a drill, to create an opening in the base of the housing. The opening in the base of the housing is intended to not pass through the base of the housing, in order to prevent entry of moisture into the housing when the original cover is later replaced on the housing.

A shaft is also included in the present invention and is extended in to the opening in the base of the housing formed by the gauge. The shaft is intended to contact the movable mounting plate for one of the contacts. The shaft fixes the position of the movable mounting plate relative to the housing base and, thus, fixes the gap between the pair of contacts in this regard.

The current invention also includes a method for setting the gap of a pair of contacts in a vehicle ignition system which employs the steps of removing the original cover from the housing, and positioning and fixing a gauge to the housing in place of the cover. The gauge includes a guide for creating an opening in the base of the housing in the form of a passageway.

The method further includes forming the opening in the base of the housing utilizing the passageway guide of the gauge for a cutting tool, such as a drill, the cutting tool then forms an opening in the base of the housing. The gauge is subsequently removed from fixation relative to the housing.

A shaft is then inserted into the opening of the base of the housing to lie against the movable mounting plate found at the base of the housing. In this manner, the movable mounting base, holding one of the contacts, fixes the gap between such contact and the other contact held to a base plate. Following insertion of the shaft into the opening, the cover to the housing is replaced.

It may be apparent that a novel and useful device and method for setting the gap of a pair of contacts in a vehicle ignition system has been hereinabove described.

It is therefore an object of the present invention to provide a device for setting the gap of a pair of contacts in a vehicle ignition system which eliminates the need for periodically setting the ignition contact or breaker gap using a feeler gauge, during engine operation.

Another object of the present invention is to provide a device for setting the gap of a pair of contacts in a vehicle ignition system that operates in an essentially permanent manner.

Another object of the present invention is to provide a device for setting the gap of a pair of contacts in a vehicle ignition system that eliminates labor and expense incurred in the past and results in the efficient operation of a vehicle engine.

A further object of the present invention is to provide a device and method for setting the gap of a pair of contacts in a vehicle ignition system that is simple in structure and avoids multiple steps when setting the timing of a vehicle ignition system.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a top plan view of an open distributor depicting the essential components supporting the pair of points or breaker contacts.

FIG. 2 is a top plan view of the distributor housing depicted in FIG. 1, showing a gage in place for formation of an opening in the base of the housing to carry out the present invention.

FIG. 3 is a top plan view of an alternate embodiment of a gauge which is positioned over the housing in substitution for the removed cover thereof.

FIG. 4 is a side sectional view of FIG. 3, depicting the formation of the opening of the base of the housing utilizing the gauge of FIGS. 2 and 3.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior delineated drawings.

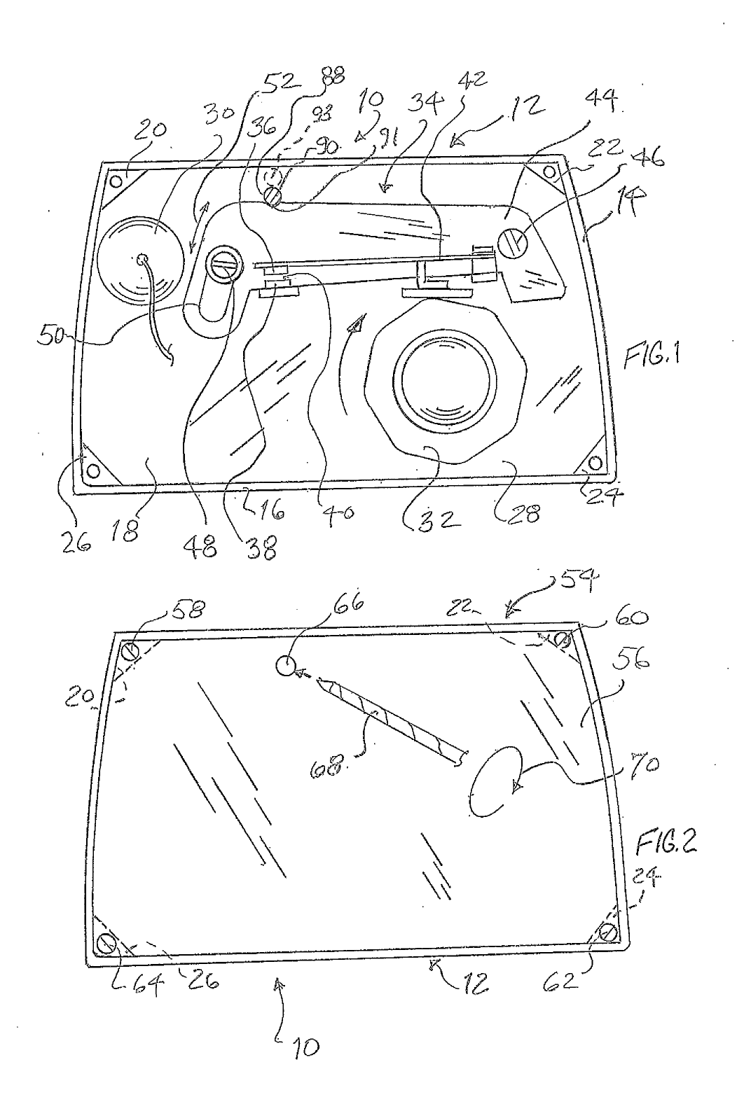

An embodiment of the invention is shown, as a whole, by reference character 10 in the drawings. Device 10 is employed in conjunction with breaker point assembly 12 which serves as part of the ignition system for a vehicle, and is depicted in FIG. 1 as a magneto. It should be noted that the device 10 of the present invention is applicable to a mechanical or electronically tuned ignition system. Breaker point assembly 12 lies within a housing 14 having a wall portion 16 extending from base 18. FIG. 1 depicts housing 14 with its cover removed. It should be realized that corner braces 20, 22, 24, and 26 provide recesses for the screws which normally hold cover (not shown) in place on housing 14. Wall portion 16 of housing 14 forms a chamber 28. Chamber 28 holds the standard vehicle ignition system components such as condenser 30 rotatable cam 32 and breaker contact apparatus 34. It should be noted that other components found within breaker point assembly 12 are not shown for the sake of clarity. Also, it should be apparent that the breaker contact apparatus includes contacts 36, and 38, having a gap 40 therebetween. Gap 40 is a critical distance which must be correct for a particular ignition system of a particular vehicle. Contact 36 lies on support arm 42 which flexes according to the turning of rotatable cam 32 to open and close gap 40 between contacts 36 and 38. Contact 38 lies on movable mounting plate 44 which pivots around pin 46. Movable mounting plate 44 may also be referred to as an ignition adjustor plate, timing plate, breaking plate, base plate, and the like, in the vehicular ignition system industry. Locking screw 48 holds or fixes the rotation of movable mounting plate 44 about pin 46.

Slot 50 allows adjustment of movable mounting plate 44 in this regard, according to directional arrow 52. Thus, in general, gap 40 is adjusted by the movement of contact 38 relative to contact 36, through the rotation of movable mounting plate 44 to adjust the timing of the ignition system associated with breaker point assembly 12. As stated heretofore, such adjustment was normally accomplished, in the prior art by the use of a feeler gauge placed in gap 40 to set the same, FIG. 1.

The present invention 10 includes the use of a gauge 54, FIG. 2. Gauge 54 is in the form a sheet or plate 56 which mimics the cover used to enclose chamber 28 of housing 14. As depicted in FIG. 2, gauge 54 is shown atop of housing 14 and fasten thereto by screws 58, 60, 62 and 64 which fit into the recesses of corner braces 20, 22, 24, and 26, respectively. Thus, gauge 54, whenever placed and fixed atop housing 14, always lies in exactly the same position relative to housing 14. An orthogonal bore 66 serves as a guide through sheet 56 of gauge 54, for a cutting tool, such as a drill bit 68. Thus, drill bit 68 when extended through guide 66 will extend to the base 18 of housing 14 and turn according to directional arrow 70.

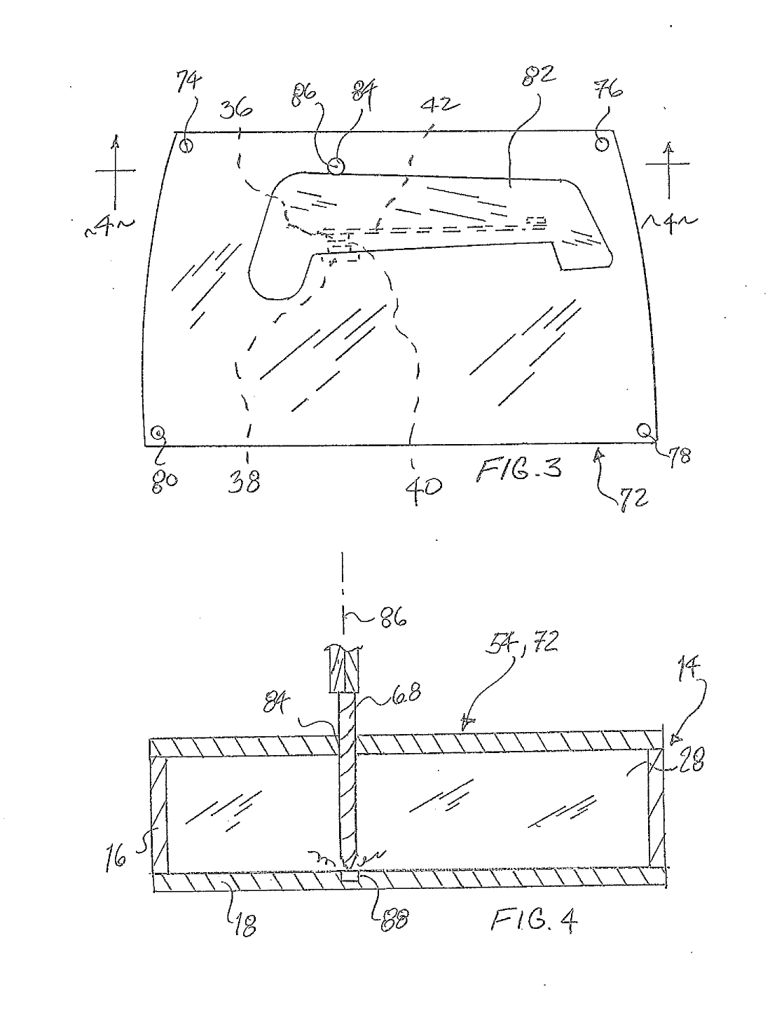

Turning to FIG. 3, it may be observed that an alternate gauge 72 is depicted, but has the same external contour as gauge 54 including screw holes 74, 76, 78, and 80. Again, screw holes 74, 76, 78, and 80 match the recesses found in braces 20, 22,24, and 26, respectively, of housing 14 to assure alignment of gauge 72 relative to housing 14, as heretofore described with respect to gauge 54. Gauge 72 includes a replica 82 of movable mounting plate 44 found therebelow in chamber 18 of housing 14. Such replica is used for the purposes of identification of gauge 72 with respect to a particular breaker contact apparatus 34. Again, an orthogonal guide or bore is shown that lies along an axis 86 to assure the true alignment of drill bit 68 through guide 84 as depicted in FIG. 4. Cutting tool 68 is used to create an opening 88 and base 18. Moveable mounting plate 44 may be removed from chamber 28 prior to this step and replaced prior to setting gap 40, described hereinafter. It may be apparent that opening 88 does not pass completely through base 18 to prevent moisture intrusion in chamber 88 when the cover of housing 14 is replaced in place of gauge 54 or gauge 72, prior described.

The position of bore 66 of gage 54 of bore 84 of gage 72 may be predetermined by measurement or by trial and error to properly position moveable mounting plate 44. In certain cases a notch 91 must cut into moveable mounting plate 44 to provide spacing of opening from wall 16. A theoretical improper opening 93 is shown I phantom on FIG. 1, in this regard.

Following the creation of opening 88 in base 18, a shaft 90, such as a set screw, is placed within opening 88 along axis 86 to limit the rotation of movable mounting plate 44 by contact. If prior removed, moveable mounting plate 44 is replaced at this time. That is to say, movable mounting member 44 will not rotate beyond the position of shaft 90. Needless to say the position of shaft 90 is predetermined by the position of opening 88 to correspond with the proper gap 40 for contacts 36 and 38. Thus, gap 40 is easily set and re-set simply by loosening locking screw 48, rotating movable mounting plate 46 against shaft 90, and retightening locking screw 48, FIG. 1.

In operation, the user of device 10 predetermines the position of guide bore 66 of gauge 54 such that the guide 84 of gauge 72 corresponds to the proper gap 40 of contacts 36 and 38 of breaker contact apparatus 34, FIGS. 1-4. The cover of housing 14 is then removed and the gauge 54 or 72 is placed atop housing 14, using the recesses found in braces 20, 22, 24, and 26 of housing 14 for proper alignment. That is to say, the screws 58, 60, 62, and 64 hold gauge 54 or gauge 72 in a consistent, predetermined, position relative to base 14. Opening 88 is then created in the base 18 of housing 14 by the use of a cutting tool, such as drill bit 68, FIG. 4. Gauge 54 or 72 is then removed from base 14 to allow access to opening 88 in base 18 of housing 14. A shaft 90 is then inserted into opening 88 of base 18. Such shaft may take the form of a threaded member such as a bolt or screw. The movable mounting plate, supporting contact 38, is then rotatably positioned against shaft 90 and fixed in place by locking screw 48. It should be noted that these steps sets gap 40 between contacts 36 and 38 at the proper distance. The cover to housing 14 is then replaced to allow usage of breaker point assembly 12.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A device for setting the gap of a pair of contacts in a vehicle ignition system having a movable mounting plate for one contact located on a base of a housing,
comprising:
a. a gauge positioned relative to the housing, said gauge including a guide for creating an opening in the base of the housing, and
b. a shaft, said shaft extending into said opening in the base of the housing and contacting the movable mounting plate for one contact, said shaft fixing the position of the movable mounting plate relative to the housing base.

2. The device of claim 1 in which the movable mounting plate pivots relative to the base and said shaft fixes the pivoting of the mounting plate.

3. The device of claim 1 in which the movable mounting supports a first contact and the vehicle ignition current source further includes a second contact positioned at a gap from the first contact, and said shaft contacting the movable mounting plate determines the gap between the first and second contacts.

4. The device of claim 1 in which said opening in the base of the housing penetrates the housing base without extending therethrough, and said shaft is supported in said opening.

5. The device of claim 1 in which said gauge comprises a plate and said guide comprises a passageway through said plate.

6. The device of claim 5 in which the movable mounting plate pivots relative to the base and said shaft fixes the pivoting of the mounting plate.

7. The device of claim 5 in which the movable mounting supports a first contact and the vehicle ignition current source further includes a second contact positioned at a gap from the first contact, and said shaft contacting the movable mounting plate determines the gap between the first and second contacts.

8. The device of claim 5 in which said opening in the base of the housing penetrates the housing base without extending therethrough, and said shaft is supported in said opening.

9. A method of setting the gap of a pair of contacts in a vehicle ignition system housing a movable mounting plate, the movable mounting plate being located within a housing having a removable cover and a base,
comprising the steps of:
a. removing the cover from the housing;
b. positioning and fixing a gauge to the housing, said gauge including a guide for creating an opening in the base of the housing;
c. creating an opening the base of the housing utilizing the guide of the gauge;
d. removing said gauge from fixation to the housing;
e. inserting a shaft into said opening in the base of the housing; and
f. replacing the cover to the housing.

10. The method of claim 9 which comprises the additional steps of:
a. removing the movable mounting plate from the housing after said step of removing the cover from the housing; and
b. replacing the mounting plate within the housing after the step of removing said gauge from fixation to the housing.
